(19) United States
(12) Patent Application Publication
(10) Pub. No.: US 2021/0019855 A1
(43) Pub. Date: Jan. 21, 2021

(54) PROXIMITY BASED CONDITIONAL REWARDS FOR CASINO USERS

(71) Applicant: IGT, Las Vegas, NV (US)

(72) Inventors: Michael Russ, Graz (AT); Stefan Keilwert, St. Josef (AT); Sven Aurich, Schwanberg (AT); David Froy, Lakeville-Westmorland (CA)

(21) Appl. No.: 16/944,319

(22) Filed: Jul. 31, 2020

Related U.S. Application Data
(63) Continuation of application No. 16/002,341, filed on Jun. 7, 2018.

(51) Int. Cl. G06Q 50/34; G06Q 30/02; G01S 19/51; H04W 4/021

(52) U.S. Cl. CPC G06Q 50/34; G06Q 30/0261; G06Q 30/0267; G06Q 30/0235; G06Q 30/0209; H04W 4/021; G01S 19/51

(57) ABSTRACT

A computer-implemented method can include determining a location of a mobile device that is proximate to a casino and that is associated with a user. The method can further includes determining a conditional reward that indicates a reward to be provided to the user in response to a condition being completed by the user. The conditional reward can be based on the location of the mobile deice relative to the casino. The method can further include transmitting a signal having the conditional reward to the mobile device and determining that the user is at the casino. The method can further include determining that the condition is completed and providing the user with the reward.

### TECHNICAL FIELD

Embodiments described herein relate to wireless communication and location tracking, and in particular to proximity based conditional rewards for casino users.

### BACKGROUND

Casinos provide players with various entertainment opportunities including table games and electronic and electro-mechanical gaming machines (EGMs). EGMs are systems that allow users to place a wager on the outcome of a random event, such as the spinning of mechanical or virtual reels or wheels, the playing of virtual cards, the rolling of mechanical or virtual dice, the random placement of tiles on a screen, etc. Manufacturers of EGMs have incorporated a number of enhancements to the EGMs to allow players to interact with the EGMs in new and more engaging ways. For example, early slot machines allowed player interaction by pulling a lever or arm on the machine. As mechanical slot machines were replaced by electronic slot machines, a range of new player interface devices became available to EGM designers and were subsequently incorporated into EGMs. Examples of such interface devices include electronic buttons, wheels, and, more recently, touchscreens and three-dimensional display screens. Casinos benefit from attracting players to gamble, keeping the players attached to the game, and re-attracting the players for future visits.

### SUMMARY

According to some embodiments, a computer-implemented method is disclosed. The method includes determining a location of a mobile device that is proximate to a casino and that is associated with a user. The method further includes determining a conditional reward that indicates a reward to be provided to the user in response to a condition being completed by the user. The conditional reward can be based on the location of the mobile device relative to the casino. The method further includes transmitting a signal comprising the conditional reward to the mobile device. The method further includes determining that the user is at the casino. The method further includes determining that the condition is completed. The method further includes providing the user with the reward.

According to further embodiments, a system is disclosed. The system includes a processor and a memory having instructions stored therein. The instructions can be executed by the processor to cause the processor to determine a location of a mobile device that is proximate to a casino and associated with a user. The instructions can further cause the processor to determine a preferred activity of the user within the casino. The instructions can further cause the processor to transmit a signal to the mobile device indicating that the preferred activity is reserved for the user during a period of time. The period of time can be based on the location of the mobile device relative to the casino. The instructions can further cause the processor to provide the mobile device with instructions to access the preferred activity in response to determining that the user is at the casino within the period of time.

According to further embodiments, another system is provided. The system includes a processor and a memory having instructions stored therein. The instructions can be executed by the processor to cause the processor to transmit a location of a mobile device that is proximate to a casino and associated with a user to a remote device associated with the casino. The instructions can further cause the processor to receive a message from the remote device in response to communicating the location of the mobile device. The message can indicate rewards that are available to the user in response to the user being at the casino. Each reward can have a limited amount of time in which to claim the reward. The instructions can further cause the processor to receive an indication of a given reward being provided to the user in response to the user being at the casino within the limited amount of time associated with the reward.

### BRIEF DESCRIPTION OF THE DRAWINGS

In the following detailed description, embodiments of the disclosure are described referring to the following figures:

FIG. 1 is a block diagram of an example of a system for providing proximity based conditional rewards to a casino user according to one aspect of the present disclosure;

FIG. 2 is a block diagram of an example of mobile device for providing proximity based conditional rewards to a casino user according to one aspect of the present disclosure;

FIG. 3 is a block diagram of an example of a remote device for providing proximity based conditional rewards to a casino user according to one aspect of the present disclosure;

FIG. 4 is a block diagram of an example of a player tracking server for providing proximity based conditional rewards to a casino user according to one aspect of the present disclosure;

FIG. 5 is a block diagram of an example of an electronic or electro-mechanical gaming machine (“EGM”) for providing proximity based conditional rewards to a casino user according to one aspect of the present disclosure;

FIG. 6 is a flow chart of an example of a process for providing proximity based conditional rewards to a casino user according to one aspect of the present disclosure;

FIG. 7 is a flow chart of an example of a process for determining a conditional reward according to one aspect of the present disclosure;

FIG. 8 is a flow chart of an example of another process for determining a conditional reward according to one aspect of the present disclosure;

FIG. 9 is a flow chart of an example of another process for determining a conditional reward according to one aspect of the present disclosure;

FIG. 10 is a flow chart of an example of another process for determining a preferred activity for a user at a casino according to one aspect of the present disclosure; and

FIG. 11 is a flow chart of an example of a process for determining a conditional reward according to one aspect of the present disclosure.

### DETAILED DESCRIPTION

Embodiments described herein relate to wireless communication and location tracking, and in particular to providing proximity based conditional rewards to casino users. A remote device associated with a casino can provide a conditional reward to a mobile device associated with a user. The conditional reward can include a reward that will be provided to the user in response to the user completing a condition. The condition and the reward can be personalized for the user and based on the proximity of the user to the casino. Providing proximity based conditional rewards can attract the player to a casino, keep the player attached to activities in the casino, and re-attract the player for following casino visits.

Users can register a mobile device with the casino (e.g., by downloading an app and creating a user account). Registered users (e.g., casino visitors or potential casino visitors) can be attracted by a casino message or push notification to the mobile device. A location of the registered user may be tracked near the casino using GPS, WiFi, or other wireless technologies. A user can be attracted by the casino to come and gamble in certain situations, for example, when the player is near the casino, in the casino environment, entering the casino, and/or on the casino floor. A mobile device associated with the user can include a wireless transceiver for determining location data (e.g., through GPS, WiFi, Bluetooth, or NFC). A remote device associated with the casino can communicate with the user to receive user preferences and provide conditional rewards to the player based on the location of the user.

In some embodiments, casinos can communicate with users (or players) to determine a personalized experience that will engage the user and lead to the user returning to the casino. For example, before a casino visit, a user can define parameters for a personal preferred casino experience (e.g., preferred games, preferred bets, preferred casino visit days). The casino can transmit personalized offerings to the user based on a position of the user relative to the casino and the parameters defined by the user. Users of the app may have personal information linked to their profile. For example, statistics regarding casino visit rate, average casino visit duration, collected bonus points, a personal player rank for specific casinos based on their customer loyalty, feasibly leading to personalized special offers for the player. The casino can determine a conditional reward for a user based on the personal information linked to the profile associated with the user.

In some embodiments, the conditional rewards can provide users with virtual currency to buy items or services from a specific casino, multiple casinos, particular EGMs, or EGM manufacturers. The virtual currency can be redeemed to download specific EGM themes, artwork, graphics, effects, etc. The virtual currency can also be used to buy casino-related merchandise, redeem points for cheaper entries at specific events in the casino, get free food, get a cheaper night in the next hotel.

The system can further record information regarding visits to casinos by registered users and provide giveaways. For example, a randomly chosen registered user with a threshold number of visits may be given the chance to have a personal backstage conversation with a start of a show at the casino. The conditional reward may be limited to registered users with weekly/monthly tombola participation among all registered app users. Conditional rewards can also include special offers on beverages, food, or entries at special events. Conditional rewards may allow users to doubled wins or place half bets during a given time period as long as the mobile device is connected to the EGM. The rewards can further include digital scratch cards on the mobile device with possible wins (whether the scratch card is a win is not revealable until the mobile device is in the casino), to be redeemed/consumed in the casino.

Casinos also gain the opportunity to communicate with individual customers based on the personal interests and location of the user rather than through non-personalized broad audience offerings. Registered users can receive attraction messages independent from their current position, such as upcoming events, welcome back bonuses, visitor of the month bonuses, loyal customer bonuses, etc. Examples of additional information the casino can send the users includes newsletters and special event offers for the casino, happy hour information, statistics of best performing games on the casino floor with live updates, free spins (if the user comes to the casino within a specific time, if they bring their friends, if they share casino visit related information with their friends, or if they come regularly), the option of reserving EGMs, the chance of trying out the newest games before others can do (e.g. in a backroom, only accessible for loyal customers), current jackpot level of a preferred game, and information about upcoming casino tournaments

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

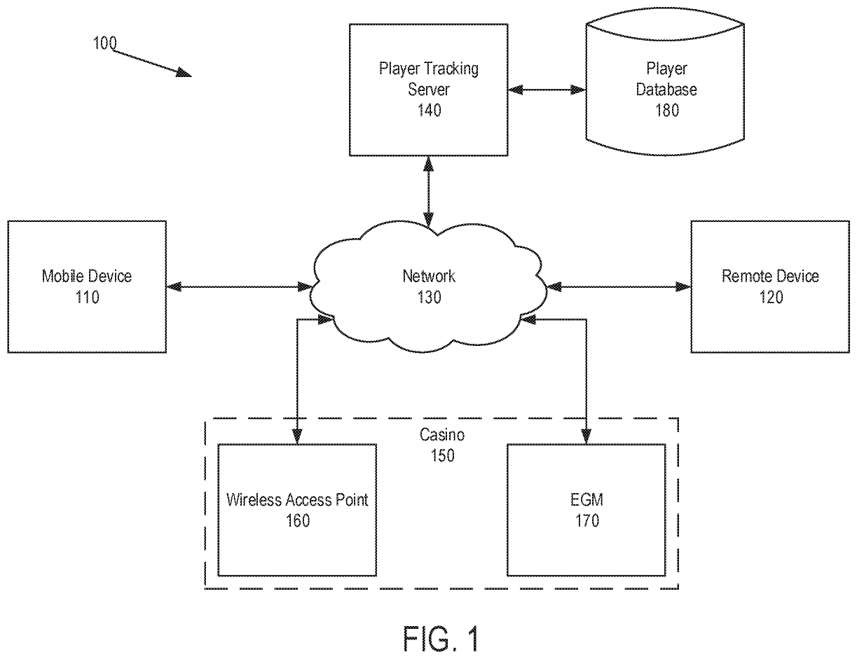

FIG. 1 illustrates an example of a system 100 for providing proximity based conditional rewards for casino users. In this example, the system includes a mobile device 110, a remote device 120, a player tracking server 140, and a casino 150 communicatively coupled by a network 130. The network 130 can allow the remote device to communicate with the mobile device 110 using various wireless communication technologies. The player tracking server 140 can be communicatively coupled to a player database 180. The casino 150 can include a wireless access point 160 and an electronic or electro-mechanical gaming machine (“EGM”) 170.

In some embodiments, a user associated with the mobile device 110 can be provided with a casino visit discount based on a proximity of the user to the casino 150. For example, a registered user five minutes away from the casino 150 may receive a notification on the mobile device 110 indicating that if the user enters the casino 150 within the next thirty minutes the user will receive five free spin bonuses. A registered user fifteen minutes away from the casino 150 may receive the same notification with more time to enter the casino 150, for example, the notification may indicate that the if the user enters the casino 150 within the next sixty minutes the user will receive five free spin bonuses.

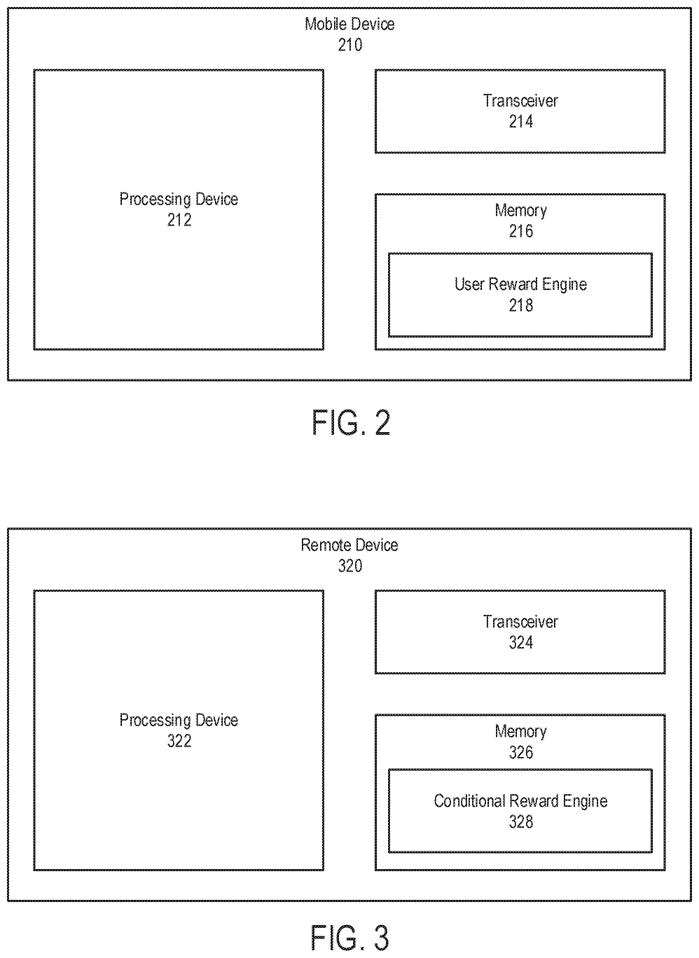

An example of the mobile device 110 is depicted as mobile device 210 in FIG. 2. The mobile device 210 includes a processing device 212, a transceiver 214, and a memory 216.

The processing device 212 can include any number of processors configured for executing program code stored in memory 216. Examples of the processing device 212 can include a microprocessor, an application-specific integrated circuit (“ASIC”), a field-programmable gate array (“FPGA”), or other suitable processor. In some aspects, the processing device 212 can be a dedicated processing device used for instructing the transceiver 214 to communicate with a remote device (e.g., remote device 120) via a network (e.g., network 130).

The processing device 212 can include (or be communicatively coupled to) a non-transitory computer readable medium. The memory 216 can include one or more memory devices that can store program instructions. The program instructions can include, for example, a user reward engine 218 that is executable by the processing device 212 to perform certain operations described herein.

In some embodiments, the user can provide information to the remote device 120, player tracking server 140, and casino 150 using the mobile device 210. The mobile device 210 can be used to reserve EGM 170 or to determine an overview of available EGMs at the casino 150. The mobile device 210 can be used prior to or during the casino visit to ordering drinks or food; check if the casino offers the player's favorite game; or submit preferred bet options, preferred themes, game types, preferred casino visit days, upload a personal profile picture (e.g., that may be displayed at the EGM 170 when connected), and general personal data. The mobile device 210 can also be used to indicate the user likes specific games and request when new games of a certain type are available or when a high score is beaten. Through GPS or Wifi connectivity of the mobile device 210, the casino can record how long the player has been on the casino floor and determine how long the player usually stays at the casino 150. Thus, if a player is statistically leaving soon the casino personnel might bring the player a special drink for free so that they stay longer. The mobile device 210 can provide both the casino 150 and the user's friends with a time of the user's next scheduled casino visit.

Returning to FIG. 1, an example of the remote device 120 is depicted as remote device 320 in FIG. 3. The remote device 320 includes a processing device 322, a transceiver 324, and a memory 326.

The processing device 322 can include any number of processors configured for executing program code stored in memory 326. Examples of the processing device 322 can include a microprocessor, an ASIC, a FPGA, or other suitable processor. In some aspects, the processing device 322 can be a dedicated processing device used for instructing the transceiver 314 to communicate with a mobile device (e.g., mobile device 110) via a network (e.g., network 130).

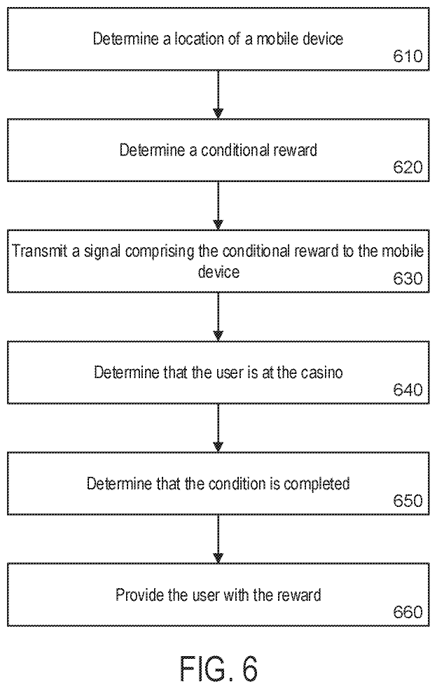

The processing device 322 can include (or be communicatively coupled to) a non-transitory computer readable medium. The memory 326 can include one or more memory devices that can store program instructions. The program instructions can include, for example, a conditional reward engine 328 that is executable by the processing device 322 to perform certain operations described herein including FIGS. 6-11.

In some embodiments, the remote device 120 can determine a location of the mobile device 110 relative to the casino 150. The remote device 120 can receive the location of the mobile device 110 from the mobile device 110, the player tracking serer 140, or the casino 150. In some examples, the player tracking server 140 monitors the location of the mobile device 110 and stores location data for the mobile device in the player database 180 along with other information regarding a user associated with the mobile device 110. The remote device 120 can determine a conditional reward based on the location of the mobile device 110 relative to the casino 150 and transmit the conditional reward to the mobile device 110. The remote device 120 can provide the user with a reward associated with the conditional reward in response to determining that he user is located at the casino and that the condition has been completed by the user.

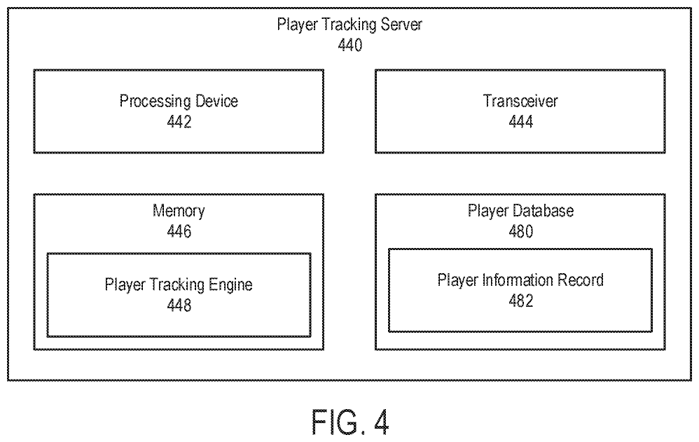

Returning to FIG. 1, an example of the player tracking server 140 and player database 180 are depicted as player tracking server 440 and player database 480 respectively in FIG. 4. The player tracking server 440 includes a processing device 442, a transceiver 444, a memory 446, and the player database 446.

The player database 480 can include one or more records of information including player information record 482. The player information record 482 can include player information for one or more registered users including a user associated with the mobile device 110. The player information record 482 can include various data on a user including a record of past locations, past casino visits, duration of past casino visits, preferred games, and friends.

The processing device 442 can include any number of processors configured for executing program code stored in memory 446. Examples of the processing device 442 can include a microprocessor, an ASIC, a FPGA, or other suitable processor. In some aspects, the processing device 442 can be a dedicated processing device used for recording information on a user associated with a mobile device (e.g., mobile device 110) in the player database 446 and instructing the transceiver 444 to communicate with a remote device (e.g., remote device 120) via a network (e.g., network 130).

The processing device 442 can include (or be communicatively coupled to) a non-transitory computer readable medium. The memory 426 can include one or more memory devices that can store program instructions. The program instructions can include, for example, a player tracking engine 446 that is executable by the processing device 442 to perform certain operations described herein.

In some example, the operations can include receiving information from mobile device 110 associated with a user via network 130 and storing the information in the player database 480. In additional or alternative examples, the operations can include retrieving information associated with the user from the player database 480 and transmitting the information to the remote device 120 via the network 130.

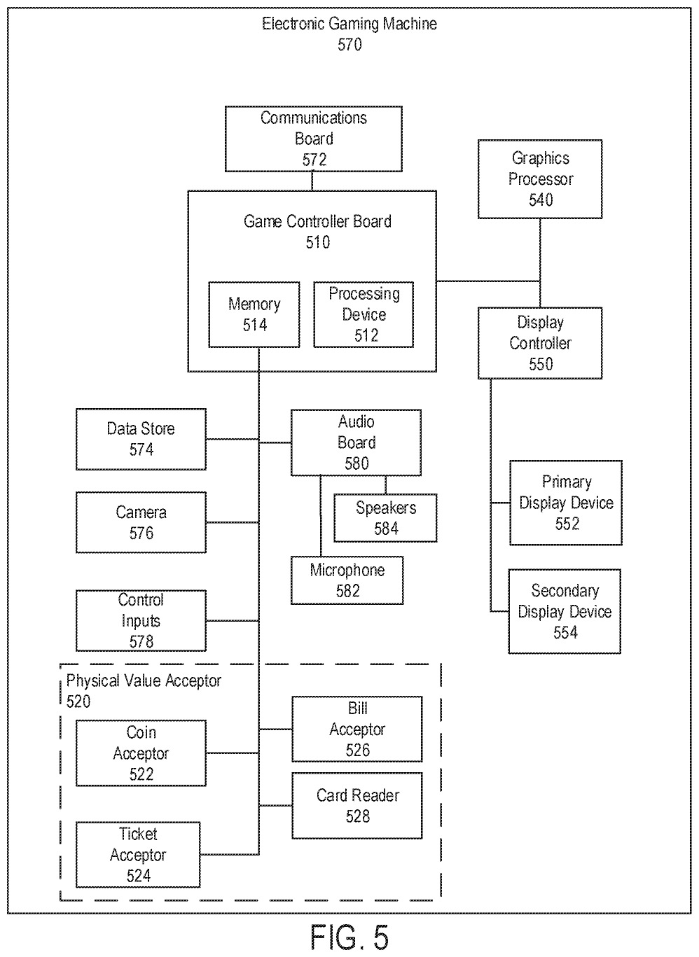

Returning to FIG. 1, an example of the EGM 170 is depicted as EGM 570 in FIG. 5. The EGM 570 includes a game controller board 510, a physical value acceptor 520, a graphics processor 640, a display controller 550, a communication board 572, a data store 574, a camera 576, control inputs 578, and an audio board 580.

The physical value acceptor 520 can include a coin acceptor 522, a ticket acceptor 524, a bill acceptor 526, and a card reader 528. In some embodiments, a physical value acceptor may include any combination of wireless and/or wired technology that accepts value from a user into the EGM 170, 570 and that includes an interface for receiving value that may be an optical and/or radio frequency interface. The display controller 550 can control a primary display device 552 and a secondary display device 554. The audio board 580 can control a microphone 582 and speakers 584.

The game controller board 510 can include a processor device 512 and a memory 514. The processing device 512 can include any number of processors configured for executing program code stored in memory 514. Examples of the processing device 512 can include a microprocessor, an ASIC, a FPGA, or other suitable processor. The processing device 512 can include (or be communicatively coupled to) a non-transitory computer readable medium. The memory 514 can include one or more memory devices that can store program instructions that are executable by the processing device 512 to perform certain operations described herein.

In some embodiments, gameplay on the EGM 570 can be adapted to current situations on the mobile device 110. In some examples, the EGM 570 can communicate with the mobile device 110 to receive information from its sensors or through its internet connection. The EGM 570 can determine the weather from the mobile device 110 and display a visualization of the player when the rain is over. The EGM 570 can determine the time from the mobile device 110 and adapt the game based on how long the player has been to the casino already. The EGM 570 can determine the local language or loudness on the casino floor from the mobile device 110 and adjust the language used in the game and sounds produced by the EGM 570 accordingly.

In additional or alternative embodiments, the EGM 570 can allow the user to input information to the EGM 570 via the mobile device 110. In some examples, the mobile device 110 can be used to play skill elements/mini games/second chance games that are part of the EGM game. In additional or alternative examples, the EGM 570 can allow the user to rate EGM games using an app or provide like/dislike comments (other players connected to the machine may be able to see how previous users voted). The EGM 570 may allow the mobile device 110 to be used as a 2nd screen (e.g., reels on full screen of the EGM 570 while the mobile device 110 is used as dashboard). The EGM 570 may display mobile device content on the EGM screen (incoming calls, messages, or fitness data from fitness tracker devices, etc.). The EGM 570 may be part of a group of EGMs that are controlled, at the same time, by the mobile device 110. The EGM 570 may also share with other users or friends on which machine the player is currently playing. For example, the EGM 570 may share the player's score with other friends on the casino floor to keep track of each other or on a friends list to show a highscore. In some examples, the EGM 570 can be locked or unlocked by the mobile device 110 such that a registered user can reserve the EGM 570 when leaving the EGM 570 for a short time (e.g., going to the bar, restrooms, having a quick look at friend's play, etc.)

In additional or alternative embodiments, the EGM 570 can communicate with the mobile device 110, remote device 120, and player tracking server 140 to adjust the game based on the user's health data. For example, the age of the user may be used to adjust the font size, the heart rate of the user may be used to determine if more tension is needed in the game to give the player an adrenaline kick. The EGM 570 may provide the mobile device 110 with achievements or additional incentives and allow the mobile device 110 to redeem them on the EGM 570 using QR-codes or other optical codes, NFC, Bluetooth, or Wifi (e.g., redeem a welcome entry bonus using the mobile device 110).

In additional or alternative embodiments, the EGM 570 may interact with the mobile device 110 by allowing the user to get game themes, skins, or designs from the EGM downloaded to the mobile device 110. The EGM 570 may allow screenshots made by the EGM during the game (e.g., during a moment of a high win) transferred to the mobile device 110. The EGM 570 may also allow the user to look for other players playing the same type of EGM 570 via an app on the mobile device 110.

Returning to FIG. 1, in some embodiments, a user can be provided with a time limited bonus discount. For example, the notification can indicate that if the user visits the casino 150 within the next one hour the user will receive five free spins or if the user visits the casino 150 within the next thirty minutes the user will receive ten free spins.

In additional or alternative embodiments, the conditional reward can include a condition or a bonus based on bringing other users to the casino 150 with the user. The condition may indicate that the user can receive a reward if he brings a minimum number of friends to the casino within a predetermined period of time and that the reward will be based on the number of friends the user brings to the casino. For example, the notification can indicate that the free spins get multiplied for each friend the user brings to the casino 150. In additional or alternative embodiments, the conditional reward can include a beverage bonus. For example, the notification can indicate that if the user visits the casino 150 this weekend with at least three other users, the user can receive a bottle of an alcoholic beverage and free soft drinks. In additional or alternative embodiments, the user can receive an offer from the casino to reserve a specific electronic gaming machine for a limited amount of time.

In additional or alternative embodiments, registered users visiting the casino repeatedly may receive an extra reward. For example, the visitation frequency of a user can be tracked by the remote device 120 or the player tracking server 140 and stored in the player database 180. The value of the reward can be increased based on the visitation frequency to motivate user to visit the casino more frequently. When a group of users returns to the casino repeatedly, the system can recognize the group of users as a group of friends and offer personalized rewards for the group coming together. The rewards can be targeted to the individual group based on their consumer behavior, gaming behavior, and general casino visit behavior.

In additional or alternative embodiments, registered casino players can take part in a non-monetary bonus or achievement system (e.g. by collect experience points). Players can collect experience points by winning and/or by losing. By collecting points, players can reach a new casino status level and eventually achieve VIP visitor status to receive additional personalized special offers by the casino.

Registered users can also join a team working to control the casino floor. Each team can collect team experience points or a team score that can be compared with each other. In response to a player's team moving down from first place in the ranking, the remote device 120 may generate a strike back message that includes a conditional reward. For example, the message may challenge the team to regain first place in the next sixty minutes to get special incentives.

The casino 150 can be broken down into zones (e.g., activities within the casino can be divided into thematic or locational subsets) and players can be place on a team or choose to join a specific team. When the team members play games, the more they play the more influence their team has on the zone. The zones can offer additional bonuses or enticements to players who play on the zone and provide rewards to teams that take over a zone. For example, while a zone is under the control of a specific team, the team can gain credits or bonuses and can be rewarded things to be unlocked in a mobile app installed on the mobile device 110. The remote device 120 can send notifications to the mobile device 110 when their zone is taken over or when their team has taken over another team's zone. The remote device 120 can also transmit notifications when the team has made progress on a prize or unlocked a new reward.

In some embodiments, the casino 150 can have a progressive that is qualified only for teams that have a large influence on a given zone or the most number of zones in the casino 150. The mobile device 110 can include or be communicatively coupled to augmented reality components such that while in the casino, the players could see the floor map with the zones and influences of the different teams.

In some embodiments, the remote device 120 can transmit notifications to registered users of tournament and provide them with access to participate in the tournament. In some examples, entrance to the tournament may require a response message from the mobile device 110. In response, the remote device 120 can notify the mobile device 110 of a terminal the user is assigned to or allow the user to select an EGM they want to play during the tournament.

In some embodiments, notifications are pushed when players get close to a casino, depending on their gaming habits. For example, remote device 120 can access information stored in the player database 180 regarding when, where, what, with whom, how long, and how frequently a user associated with the mobile device 110 plays such that players that are more often in the casino might receive bonus notifications more often than players who don't come as regularly. Furthermore, the remote device 120 may transmit a conditional reward to the mobile device 110 in response to determining that a friend of the user is already at the casino 150.

Although the system 100 depicts the mobile device 110 communicatively coupled directly to the player tracking server 140 and the casino 150 via the network 130, in alternative embodiments the mobile device 110 is directly communicatively coupled to the remote device 120 and only indirectly communicatively coupled to the other components via the remote device 120.

Although the components in system 100 are depicted as separate and independent, the components can be provided in a single device or spread across various devices and locations. For example, the remote device 120 can include one or more of the player tracking server 140, the player database 142, the wireless access point 160, or the electronic gaming machine 170. In additional or alternative examples, the casino 150 can include the remote device 120, the player tracking server 140, and the player database 142.

FIG. 6 depicts an example of a process for providing proximity based conditional rewards to casino users. The process is described below in reference to system 100 of FIG. 1, but the process can be performed by any suitable system.

In block 610, remote device 120 determines a location of mobile device 110. The remote device 120 can determine the location of the mobile device 110 is proximate to the casino 150 and that the mobile device 110 is associated with a user. In some embodiments, the remote device 120 can determine the location of the mobile device 110 by receiving location data from the mobile device 110. In some examples, the remote device 120 transmits a location request to mobile devices associated with a group of registered users and receives the location of the mobile device 110 in response to the request. In additional or alternative examples, the remote device 120 can periodically receive location data from the mobile device 110.

The remote device 120 can determine the location of the mobile device 110 based on various location data. In some examples, the location data can include a GPS location or a street address. In additional or alternative examples, the location data can include an IP address and the remote device can determine the location of the mobile device 110 based on the IP address. In additional or alternative examples, the location data can be an amount of time for the user to arrive at the casino 150 generated by a navigation system on the mobile device 110.

In additional or alternative embodiments, the remote device 120 determines the location of the mobile device 110 based on a type of wireless communication technology used to form the wireless connection between the remote device 120 and the mobile device 110 or a location of an access point used by the mobile device 110 to access the network 130. The remote device 120 can communicate with the mobile device 110 using various wireless communication technologies. In some examples, the remote device 120 can communicate with the mobile device 110 using telecommunication networks, WiFi, Bluetooth, or near-field communication (“NEC”).

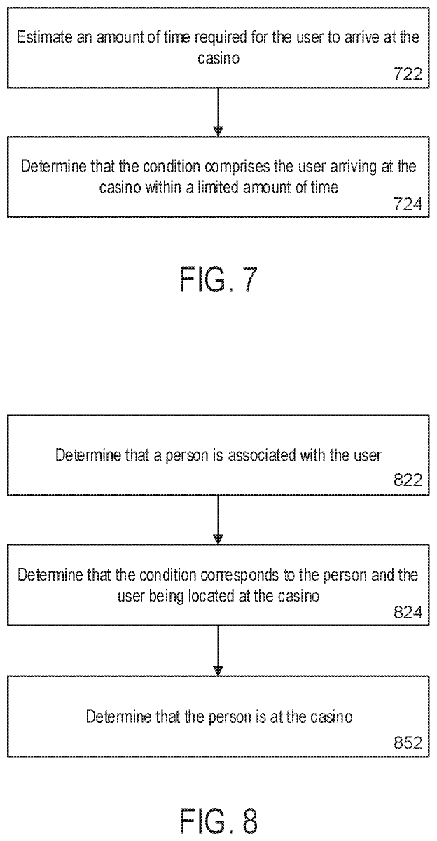

In block 620, remote device 120 determines a conditional reward. The conditional reward can include one or more rewards that may be provided to the user upon completion of one or more conditions. The conditions can be beneficial to the casino 150, for example, the user arriving to play at the casino within a limited amount of time and bringing other players. The rewards can be beneficial to the user, for example, free play and discounts at the casino 150. The value of the reward can be based on a referral by the user, a frequency of visits by the user to the casino, a duration of visits by the user at the casino, a point status of the user, or an activity previously performed by the user at the casino. Examples of processes for determining the conditional reward are described in FIGS. 7-11.

FIG. 7 depicts an example of a process for determining the conditional reward that may incentivize the user to come to the casino within a limited amount of time. In block 722, remote device 120 estimates an amount of time required for the user to arrive at the casino. The remote device 120 can estimate the amount of time required for the user to arrive at the casino based on the location of the mobile device 110 using a navigation system. For example, the remote device 120 may determine the user is a twenty-minute walk from the casino 150. In block 724, remote device 120 determines that the condition includes the user arriving at the casino within a limited amount of time. The limited amount of time can be based on the amount of time required for the user to arrive at the casino.

FIG. 8 depicts an example of another process for determining the conditional reward that may incentivize the user to bring other players to the casino 150. In block 822, remote device 120 determines that a person is associated with the user. The remote device 120 can determine that a person is associated with the user based on information provided by the user to the remote device 120 (e.g., an indication that the person is a friend). The remote device 120 may determine that a person is associated with the user based on social media connections, shared room information, or detecting correlations between location data of the person and the user.

In block 824, remote device 120 determines that the condition corresponds to the person and the user being located at the casino. In some examples, the condition can be an additional requirement for any reward or a requirement for an additional reward. The additional reward can be intended for the user, the person, or both.

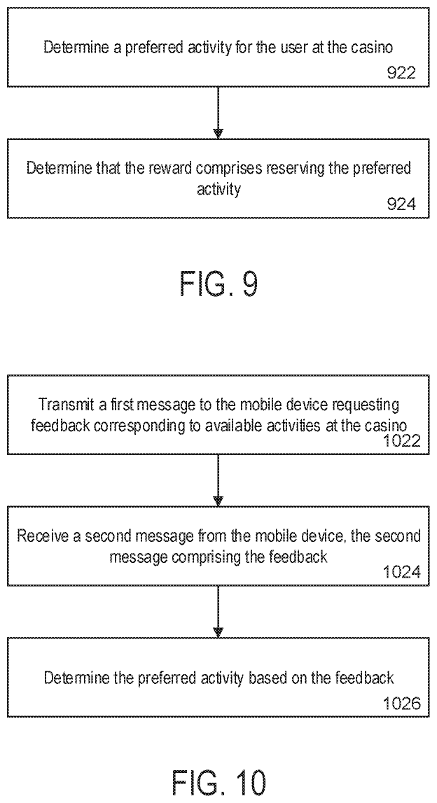

FIG. 9 depicts an example of another process for determining the conditional reward that may provide more personalized incentives to the user. In block 922, remote device 120 determines a preferred activity for the user at the casino. The preferred activity can be a EGM, game table, spa, pool, room, and/or meal at (or provided by) the casino 150. In some examples, the remote device 120 can determine the preferred activity by accessing records of the past activities and frequency of past activities performed by the user at the casino 150. FIG. 10 depicts an additional or alternative example of determining a preferred activity for the user at the casino. In block 1022, remote device 120 transmits a first message to the mobile device 110 requesting feedback corresponding to available activities at the casino. In block 1024, remote device 120 receives a second message from the mobile device 110 that includes the feedback. In block 1026, remote device 120 determines the preferred activity based on the feedback.

Returning to FIG. 9, in block 924, remote device 120 determines that the reward includes reserving the preferred activity. The remote device 120 can determine that the preferred activity is currently available or can be reserved for a specific time and include in the conditional reward the opportunity to reserve the preferred activity. In some examples, the remote device 120 may reserve the preferred activity and release the reservation if the user fails to complete the condition or fails to respond within a limited amount of time. In additional or alternative examples, the remote device 120 may monitor the location of the mobile device 110 after providing the conditional reward to th user to determine if the user is approaching the casino 150 and reserve or release the preferred activity based on the location of the mobile device 110.

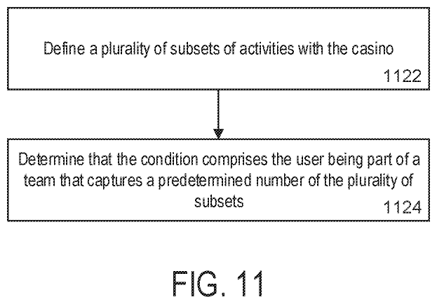

FIG. 11 depicts an example of another process for determining a conditional reward that may incentivize playing subsets of activities within the casino 150. In block 1122, remote device 120 defines subsets of activities within the casino. In some examples, the remote device 120 can define table games into one subset and EGMs into another subset. In additional or alternative examples, the subsets can be based on location of the activity within the casino such that proximate activities are part of a common subset. In block 1124, remote device 120 determines that the condition includes the user being part of a team that captures a predetermined number of the plurality of subsets. A user may choose to be a member of a specific team or be placed on a specific team. The user's team can be determined upon the user entering the casino 150 or the user's team may be semi-permanent such that the user remains a member of the team while not at the casino 150. Capturing a subset of the activities can include a team having earned a combined score from the activities within the subset or a number of activities within the subset being performed by members of a team.

Returning to FIG. 6, in block 630, remote deice 120 transmits a signal comprising the conditional reward to the mobile device 110. In some examples, the remote device 120 can request the user confirm receipt of the offer or conditional reward within a limited amount of time and provide further communication based on a response by the user. The signal or subsequent communications can further include directions to the casino 150 and provide the user with opportunities to personalize their visit to the casino 150.

In block 640, remote device 120 determines that the user is at the casino. In some embodiments, the remote device 120 determines the user is at the casino by detecting the location of the mobile device 110 using a distinct wireless communication technology from how the remote device determined the location of the mobile device 110 in block 610. In some examples, the remote device 120 may determine the user is in the casino 150 by communicating with the mobile device 110 via a short-range wireless communication network provided by the casino 150. In additional or alternative examples, the remote device 120 may determine the user is in the casino 150 by determining that the mobile device 110 is communicatively coupled with the wireless access point 160 or EGM 170 in the casino 150.

In additional or alternative embodiments, the remote device 120 can determine that the user is in the casino separate from determining a location of the mobile device 110. The remote device 120 can receive a notification that the user has provided identification within the casino 150. For example, the user may log in to EGM 170 or provide authentication at another terminal within the casino 150.

In block 650, remote device 120 determines that the condition is completed. In some examples, the remote device 120 can determine that the condition is completed by determining the user is in the casino 150 prior to expiration of a timer. In additional or alternative examples, the remote device can receive notification that other conditions are completed such as (in block 852 of FIG. 8) determining that a person associated with the user is at the casino 150.

In block 660, remote device 120 provides the user with the reward. The remote device 120 may transmit the reward or access to the reward to the mobile device 110. For example, the remote device 120 may transmit a code for free spins to the mobile device 110. The remote device 120 may credit the reward to a player account stored in the player database 180 or notify EGM 170 directly.

In some embodiments, the conditional reward includes a first condition that is associated with a first reward and a second condition that is associated with a second reward. The first condition can include the user arriving at the casino with a first limited amount of time and the second condition can include the user arriving at the casino with a second limited amount of time. The second limited amount of time can be less than the first limited amount of time and the second reward can be more desirable than the first reward.

Although FIGS. 6-11 are described from the perspective of remote device 120 in system 100, some embodiments can be performed by the other components in the system 100 including mobile device 110 to provide proximity based conditional rewards to casino users. For example, mobile device 110 can transmit a location of the mobile device 110 to remote device 120. The mobile device 110 may transmit the location in response to the mobile device 110 determining that the mobile device 110 is located proximate to the casino 150 and determining the remote device 120 is associated with the casino 150.

The mobile device 110 can receive a message from the remote device 120 in response to communicating the location of the mobile device 110. The message can indicate a plurality of rewards that are available to the user in response to the user being at the casino. Each reward of the plurality of rewards can include a limited amount of time in which to claim each reward of the plurality of rewards. The mobile device 110 can further receive an indication of a given reward of the plurality of rewards being provided to the user in response to the user being at the casino 150 within the limited amount of time associated with the reward.

In some examples, the mobile device 110 can transmit the location of the mobile device 110 using a first wireless communication technology and transmit a signal to the remote device using a second wireless communication technology distinct from the first wireless communication technology in response to the user being at the casino. The mobile device 110 may transmit the location of the mobile device 110 by transmitting a GPS location of the mobile device 110 to the remote device 120 via a telecommunications network and may indicate to the remote device 120 that the user is in the casino 150 by communicating over a short-range wireless communication network available at the casino 150.

In some examples, the mobile device 110 may transmit feedback to the remote device 120. The feedback can include a rating of a plurality of EGMs at the casino 150. The plurality of rewards can include an opportunity to reserve an EGM of the plurality of EGMs at the casino 150 for a specific period of time. The specific period of time can be based on the location of the mobile device 110 relative to the casino 150 and the EGM being selected from the plurality of gaming machines based on the feedback.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented by hardware (including as stand-alone printed circuit boards (PCBs), induction coils, RGB LEDs, etc.), by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A computer-implemented method comprising:
determining a location of a mobile device that is proximate to a casino and that is associated with a user;
determining a conditional reward that indicates a reward to be provided to the user in response to a condition being completed by the user, the conditional reward being based on the location of the mobile device relative to the casino;
transmitting a signal comprising the conditional reward to the mobile device;
determining that the user is at the casino;
determining that the condition is completed based on determining that the user is at the casino; and
responsive to determining that the condition is completed, providing the user with the reward.

2. The method of claim 1, wherein determining the location of the mobile device comprises using a first wireless communication technology, wherein determining that the user is at the casino comprises determining that the mobile device is at the casino using a second wireless communication technology distinct from the first wireless communication technology.

3. The method of claim 2, wherein determining the location of the mobile device comprises receiving an additional signal from the mobile device via a telecommunications network, the additional signal comprising a global positioning system (“GPS”) location of the mobile device, wherein determining that the mobile device is at the casino comprises communicating with the mobile device using a short-range wireless communication network that is at the casino.

4. The method of claim 1, wherein determining the conditional reward comprises:
estimating an amount of time required for the user to arrive at the casino based on the location of the mobile device; and
determining that the condition comprises the user arriving at the casino within a limited amount of time, the limited amount of time being based on the amount of time required for the user to arrive at the casino.

5. The method of claim 4, wherein the condition is a first condition that is associated with a first reward, the first condition comprising and comprises the user arriving at the casino within a first limited amount of time,
wherein determining the conditional reward further comprises determining a second condition that is associated with a second reward, the second condition comprising comprises the user arriving at the casino within a second limited amount of time,
wherein the second limited amount of time is being less than the first limited amount of time, and
wherein the second reward is determined to be of greater value being more desirable than the first reward.

6. The method of claim 1, wherein determining the conditional reward comprises:
determining that a person is associated with the user; and
determining that the condition corresponds to the person and the user being located at the casino,
wherein determining that the condition is completed further comprises determining that the person is at the casino, and
wherein the conditional reward includes a first reward to be provided to the user in response to the condition being completed and a second reward to be provided to the person in response to the condition being completed.

7. The method of claim 1, wherein determining the conditional reward comprises:
determining a preferred activity for the user at the casino; and
determining that the reward comprises reserving the preferred activity such that the preferred activity is made available to the user in response to the condition being completed.

8. The method of claim 7, wherein determining the preferred activity for the user comprises:
transmitting a first message to the mobile device requesting feedback corresponding to available activities at the casino;
receiving a second message from the mobile device, the second message comprising feedback corresponding to available activities at the casino; and
responsive to receiving the second message, determining the preferred activity based on the feedback.

9. The method of claim 1, wherein determining the conditional reward comprises:
determining the reward based on a referral by the user, a frequency of visits by the user to the casino, a duration of visits by the user at the casino, a point status of the user, or an activity previously performed by the user at the casino.

10. The method of claim 1, wherein determining that the user is at the casino comprises detecting use of an identification that is associated with the user at an electronic or electro-mechanical gaming machine (“EGM”) in the casino.

11. The method of claim 1, wherein determining the conditional reward comprises:
defining a plurality of subsets of activities within the casino;
determining that the condition comprises the user being part of a team that captures a predetermined number of the plurality of subsets, wherein the team captures a subset of the plurality of subsets by the team obtaining a highest score associated with the subset.

12. The method of claim 1, wherein determining the conditional reward comprises:
determining that the condition corresponds to the user bringing a minimum number of friends to the casino; and
determining that a value of the reward increases based on a number of friends that the user brings to the casino above the minimum number,
wherein determining that the condition is completed further comprises:
determining the number of friends of the user located at the casino;
determining that the number of friends is above the minimum number; and
determining the value of the reward based on the number of friends above the minimum number.

13. A system comprising:
a processor; and
a memory comprising instructions stored therein, the instructions executable by the processor to cause the processor to:
determine a location of a mobile device that is proximate to a casino and associated with a user;
determine a preferred activity of the user within the casino;
transmit a signal to the mobile device indicating that the preferred activity is reserved for the user during a period of time, the period of time being based on the location of the mobile device relative to the casino; and
provide the mobile device with instructions to access the preferred activity in response to determining that the user is at the casino within the period of time.

14. The system of claim 13, wherein the instructions to cause the processor to determine the location of the mobile device comprise instruction to cause the processor to use a first wireless communication technology, the instructions being further executable to cause the processor to determine that the user is at the casino using a second wireless communication technology that is distinct from the first form of wireless communication.

15. The system of claim 14, wherein the instructions to cause the processor to determine the location of the mobile device comprise instructions to cause the processor to receive an additional signal from the mobile device via a telecommunications network, the additional signal comprising a global positioning system (“GPS”) location of the mobile device, wherein the instructions to cause the processor to determine the user is at the casino comprise instructions to cause the processor to communicate with the mobile device using a short-range wireless communication network that is available at the casino.

16. The system of claim 13, wherein the instructions are further executable by the processor to cause the processor to:
determine a conditional reward that indicates a reward to be provided to the user in response to a condition being completed by the user, the reward being based on the location of the mobile device relative to the casino and the conditional reward comprising the reservation of the preferred activity, wherein the instructions to cause the processor to determine the conditional reward comprise instructions to cause the processor to:
estimate an amount of time required for the user to arrive at the casino based on the location of the mobile device;
determine that the condition comprises the user arriving at the casino within a limited amount of time, the limited amount of time being based on the amount of time required for the user to arrive at the casino.

17. The system of claim 16, wherein the condition is a first condition that is associated with a first reward and that comprises the user arriving at the casino within a first limited amount of time, wherein the instructions to cause the processor to determine the conditional reward further comprise causing the processor to determine that a second condition associated with a second reward comprises the user arriving at the casino within a second limited amount of time, the second limited amount of time being less than the first limited amount of time and the second reward being more desirable than the first reward.

18. A mobile device comprising:
a processor; and
a memory comprising instructions stored therein, the instructions executable by the processor to cause the processor to:
based on determining that a first location of the mobile device is proximate to a casino, transmit a first message to a system associated with the casino indicating that the mobile device is proximate to the casino and a parameter for a casino experience;
based on the first message, receive, from the system, a second message indicating a plurality of available rewards and an indication that the parameter for the casino experience can be satisfied, wherein claiming a reward of the plurality of available rewards requires the mobile device to be at a second location within a limited amount of time;
monitor for changes in the location of the mobile device; and
based on a determination that the mobile device reached the second location within the limited amount of time, receive, from the system, a third message indicating that the reward is available.

19. The mobile device of claim 18, wherein the determination that the mobile device reached the second location within the limited amount of time is based on the mobile device connection to a device of the casino using a first wireless communication technology, wherein the first location was determined using a second wireless communication technology.

20. The mobile device of claim 18, wherein the plurality of rewards comprises an opportunity to reserve an EGM at the casino for a period of time, the period of time being based on the first location of the mobile device relative to the casino and the EGM being selected based on the parameter for the casino experience.
